(19) United States
(12) Patent Application Publication
(10) Pub. No.: US 2025/0028843 A1
(43) Pub. Date: Jan. 23, 2025

(54) CRYPTOGRAPHIC AGILITY FOR A VIRTUAL STORAGE AREA NETWORK (VSAN)

(71) Applicant: VMware LLC, Palo Alto, CA (US)

(72) Inventors: Daniel James BEVERIDGE, Valrico, FL (US); Sean HUNTLEY, Sydney (AU); David OTT, Chandler, AZ (US)

(21) Appl. No.: 18/356,836

(22) Filed: Jul. 21, 2023

(51) Int. Cl. G06F 21/60; G06F 3/06; G06F 9/455

(52) U.S. Cl. CPC G06F 21/602; G06F 3/062; G06F 3/0664; G06F 3/0689; G06F 9/45558; G06F 2009/45579

(57) ABSTRACT

The disclosure provides an approach for providing cryptographic agility for virtualized data storage. Embodiments include determining, by a hypervisor running on a host machine, one or more attributes of a virtual machine (VM) running on top of the hypervisor. Embodiments include sending, by the hypervisor, to a cryptographic provider component, a request to perform cryptographic functionality with respect to one or more virtual disks associated with the VM, wherein the request comprises the one or more attributes of the VM. Embodiments include selecting, by the cryptographic provider component, based on the one or more attributes of the VM and one or more cryptographic policies, one or more cryptographic techniques for handling the request from a set of possible cryptographic techniques. Embodiments include encrypting the one or more virtual disks in a virtual storage area network (VSAN) based on the selected one or more cryptographic techniques.

### BACKGROUND

Cryptography generally involves techniques for protecting data from unauthorized access. For example, data stored in a computing system may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Some cryptographic algorithms may result in a higher level of security (e.g., having more bits of security, more layers of security, larger amounts of entropy, and/or the like) than others, and there may be trade-offs with respect to resource requirements such that higher-security algorithms may require larger amounts of storage, processing, and/or communication resources. Furthermore, new cryptographic algorithms and libraries are developed on an ongoing basis to meet changing security needs. Cryptographic libraries are collections of cryptographic algorithms that can be invoked, such as through calls to application programming interface (API) functions provided by the libraries, in order to perform various cryptographic functions (e.g., encryption of data). In some cases, weaknesses in particular algorithms may be discovered over time such as due to advances in computing technology (e.g., a particular algorithm may be susceptible to being compromised through the use of computing devices with more power than the computing devices that were in use at the time the algorithm was developed). For example, algorithms may become problematic and/or become less useful for a variety of reasons, such as due to algorithmic compromise (e.g., a weakness in the algorithm may be discovered and/or exploited), compute performance increases (e.g., the time required to “guess correctly” may be reduced), and/or the like. In some cases, new and/or updated algorithms may be developed to address these issues (e.g., by adding additional bits of security, additional layers of security, more complex forms of encryption, and/or the like).

The rise of quantum computing has raised the possibility of additional issues related to cryptography. For example, the high levels of computational power provided by quantum computing may enable nefarious actors to more easily access data secured with existing cryptographic algorithms, thereby gaining access to sensitive data that was previously believed to be secure.

The dynamic nature of computing technology and the variety of threats that exist to data security necessitate a continuous adapting of cryptography to meet these new circumstances and threats. Furthermore, laws and/or regulations may require certain types of cryptography to be utilized in certain contexts. Thus, compliance with such laws and/or regulations may further necessitate adopting of new and/or different types of cryptographic algorithms.

Conventional computer storage systems are generally designed to implement and/or utilize particular cryptographic algorithms. These algorithms may be customizable in certain respects, but there is generally no convenient mechanism for changing the cryptographic algorithms utilized by a computing storage system without modifying the base code of the computing applications involved, essentially requiring portions of the code to be rewritten, which is time consuming and difficult. Such code modifications are expensive and error-prone, particularly when done on a regular basis to address the ever-changing landscape of computing security.

For certain types of computing storage systems, such as virtual storage area networks (VSANs), conventional cryptographic techniques generally involve uniformly encrypting all data stored in such systems using fixed cryptographic algorithms. For example, all virtual disks associated with a virtual machine (VM) are conventionally encrypted using the same fixed cryptographic algorithm that the virtualization system is configured to employ. These conventional techniques are rigid, non-extensible, non-adaptable, and may result in unnecessary utilization of computing resources to encrypt data with a level of encryption that is not needed or not appropriate for the type of data, and/or may result in poor security through the use of cryptographic techniques that are outdated, compromised, and/or otherwise not secure enough for the type of data being stored.

As such, there is a need for improved cryptography techniques for computing storage systems that allow for extensibility, flexibility, and cryptographic agility.

### BRIEF DESCRIPTION OF THE DRAWINGS

FIG. 1 is a diagram illustrating an example computing environment in which embodiments of the present application may be practiced.

FIG. 2 is a diagram illustrating an example hierarchical structure of objects organized within an object store that represent one or more virtual disks for which cryptographic techniques are dynamically selected, according to an example embodiment of the present application.

FIG. 3 is an illustration of example computing components related to cryptographic agility for virtualized data storage, according to embodiments of the present disclosure.

FIG. 4 is an illustration of tagging cryptographic techniques related to cryptographic agility for virtualized data storage.

FIG. 5 depicts example operations related to cryptographic agility for virtualized data storage according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to providing cryptographic agility for data storage. In particular, the present disclosure provides an approach for enabling cryptographic agility for virtualized computing storage systems such as a virtual storage area network (VSAN) via integration with a cryptographic agility system that enables dynamic configuration, extensibility, automated selection, and implementation of optimal cryptographic techniques for particular data objects such as virtual disks.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, such as applications related to a VSAN, and is implemented in one or more separate components. For example, a cryptographic agility system described herein may expose an application programming interface (API) providing generic cryptographic methods that can be invoked by one or more components associated with a VSAN in order to provide dynamic and performant cryptographic functionality, such as dynamic selection on encryption techniques for individual virtual disks. For example, a hypervisor running on a host machine, when creating or otherwise managing a virtual disk, may invoke an API exposed by a cryptographic agility system described herein in order to request dynamic selection of cryptographic techniques for use in encrypting the virtual disk. The cryptographic agility system may select such encryption techniques based on policies and/or based on attributes related to the virtual disk that is to be stored, such as based on metadata (e.g., tags) associated with a virtual machine (VM) to which the virtual disk corresponds, metadata of the virtual disk itself, and/or other contextual information.

Thus, rather than relying on fixed cryptographic functionality, embodiments of the present disclosure involve dynamic cryptography that is provided by a separate cryptographic agility system. In certain embodiments, the cryptographic agility system dynamically determines which libraries, algorithms, configuration values, and/or the like to select based on factors such as the type of data stored in a virtual disk, the type of VM and/or application(s) associated with the virtual disk, the computing environment(s) in which the data is to be stored, geographic locations associated with storage of the virtual disk, attributes of users associated with the virtual disk, the purpose of the virtual disk (e.g., primary storage, paging, and/or the like), regulatory environments related to the encryption, network conditions, resource availability (e.g., on devices performing encryption and/or decryption, and/or storage availability), performance constraints, device capabilities, and/or the like.

For example, policies may be defined by users (e.g., administrators), and may specify rules for selecting and/or configuring cryptographic algorithms. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like.

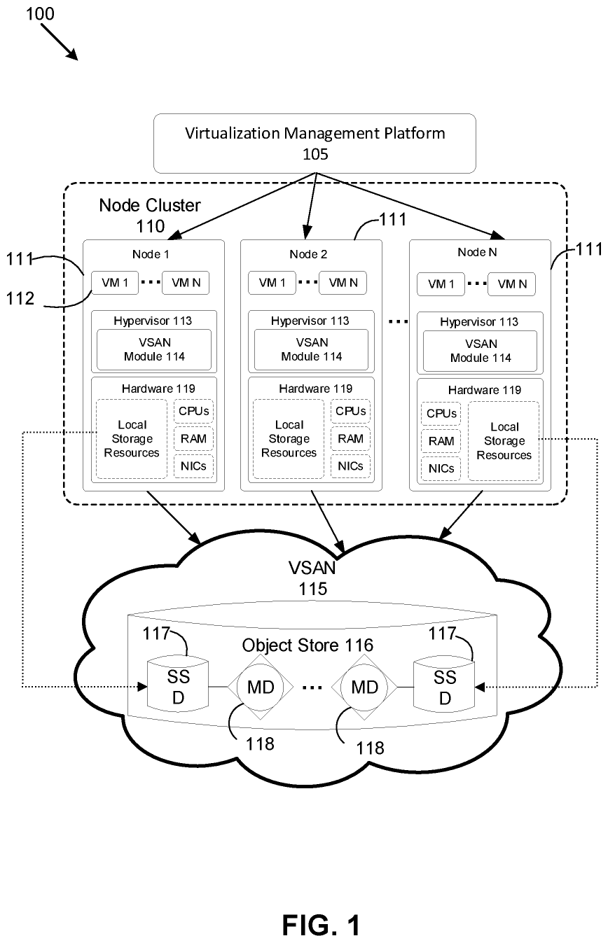

In one example, cryptographic techniques (e.g., algorithms and/or configurations of algorithms) are tagged with different levels of security (e.g., rated from 0-10), and a policy associated with a VSAN may specify that all virtual disks associated with a particular type of VM or having one or more particular characteristics (e.g., having metadata indicating that the data is sensitive), are to be encrypted using a high-security algorithm (e.g., rated 8 or higher). Thus, if a virtual disk is being created for a given VM, and contextual information indicates that the VM is of the particular type or that data stored in the virtual disk has one or more of the particular characteristics, in certain embodiments, the cryptographic agility system will select a cryptographic algorithm tagged as a high-security algorithm, such as with a security rating of 8 or higher. In certain cases, as described in more detail below with respect to FIGS. 1-3, the cryptographic agility system is associated with (or runs within) the hypervisor, and dynamically selects cryptographic techniques for use in encrypting a virtual disk before it is stored. Similar arrangements may be implemented for other types of storage systems, such as file systems and blob storage systems. In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard. Cryptographic techniques may be tagged with classifications (e.g., indicating security levels, threats protected against, and/or the like), which may take a variety of forms, such as high, medium, and low, numerical scales (e.g., 0-10), binary indications, and/or the like. In some embodiments, classifications may be imported from one or more sources, such as cryptographic technique providers, open source entities, standards bodies, and/or the like.

In yet another example, cryptographic techniques are tagged with indications of whether they have certain characteristics or support certain configurations, and a policy may specify that all data that is to be transmitted as part of a data aggregation process is to be encrypted using a cryptographic technique that does or does not have one or more particular characteristics or configurations. Thus, if the cryptographic agility system receives a request to encrypt an item of data for a data aggregation process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

By decoupling cryptographic logic from a VSAN that relies upon cryptographic functionality, techniques described herein provide flexibility and extensibility, thus allowing cryptographic algorithms to be continually updated, changed, and otherwise configured without requiring modifications to the VSAN or associated applications (e.g., hypervisor components) themselves. Accordingly, changing circumstances and new threats may be addressed in a dynamic and efficient manner, and computing security may thereby be improved.

In some embodiments, one or more cryptographic provider components of the cryptographic agility system include logic for analyzing information associated with a cryptographic request related to a virtual disk according to rules and/or policies in order to select among a library of available cryptographic techniques (e.g., that may be registered with the cryptographic agility system by an administrator). A cryptographic provider component may include a cryptographic router that selects between different cryptographic implementation components for performing selected cryptographic techniques. For example, as requests from one or more components are received at the cryptographic provider, the cryptographic router may ensure that the requests are handled by appropriate modules that perform cryptographic techniques. In some embodiments, cryptographic implementation components are executable components that perform particular cryptographic functionality, such as encrypting or decrypting data using particular cryptographic algorithms. The cryptographic implementation components may be loaded as needed based on selection of cryptographic techniques for servicing particular requests. In some cases, more than one cryptographic implementation component that performs a given cryptographic technique may be loaded, and the cryptographic router may perform load balancing and/or prioritization functionality to assign requests to particular cryptographic implementation components.

In a cryptographic agility system, an initial stage of selecting a cryptographic technique may involve ensuring that the security requirements for a given cryptographic operation, such as a level of security required by policy and/or context information, are met. In some cases, there may be multiple algorithms and/or configurations of algorithms that meet these requirements. Resource-related considerations may also be factored into the determination of which algorithms and/or configurations to use, such as based on device performance metrics and/or capability information. In one example, the cryptographic agility system selects a cryptographic technique with a highest security rating of those that comply with all relevant policies and/or resource constraints related to a particular storage request.

Thus, the cryptographic agility system may select algorithms and/or configurations of algorithms that are best suited to the context, resource availability, performance, and/or capabilities of the applications and/or devices associated with a request to perform a cryptographic operation with respect to storing data.

In some cases, cryptographic algorithms and/or configurations of algorithms may be dynamically switched over time for data that has already been encrypted and stored, such as based on changing circumstances. For example, if a policy changes such that a given item of stored encrypted data no longer complies with the policy, the cryptographic agility system may select a new cryptographic technique for the given item of data that is policy-compliant, and may decrypt and re-encrypt the item of data using the new cryptographic technique. For example, if a virtual disk is migrated, replicated, or otherwise moved from one device to another device that may have different characteristics (e.g., being in a different geographic location, having different resource availability, and/or the like), the virtual disk may need to be decrypted and re-encrypted with a different cryptographic technique that is suited to the device to which the virtual disk is moved or replicated. In certain cases, if a virtual disk is stored in a fault-tolerant configuration, such as a RAID configuration, the same or different cryptographic techniques may be selected for encrypting each object in the configuration, such as each of a plurality of redundant virtual disks. In one example, two redundant copies of a virtual disk are stored on devices in different geographic locations and/or having different characteristics, and different cryptographic techniques may be selected for the two redundant copies according to the differing contextual information related to storage of the two copies.

In some embodiments, a component associated with a VSAN occasionally (e.g., at certain intervals) performs a compliance check for virtual disks stored in the VSAN to ensure that each virtual disk is encrypted with an optimal and/or policy-compliant cryptographic technique. As new cryptographic techniques become available and are registered with the cryptographic agility system, these newly added cryptographic techniques may in some cases be better suited to particular virtual disks that are stored in the storage system than the previously-used cryptographic techniques, and these virtual disks may in some cases be decrypted and re-encrypted using the newly added cryptographic techniques.

In some cases, VMs may be tagged with metadata (e.g., by an administrator of a data center), and the tags associated with a VM may be used by the cryptographic agility system to select a cryptographic technique for use in encrypting a virtual disk associated with the VM. For example, if a VM is associated with a tag indicating that the VM contains a particular type of sensitive information and a policy indicates that the particular type of sensitive information requires encryption having a certain level of security (e.g., 7 out of 10 or higher), then a cryptographic technique having the required level of security may be selected for encrypting a virtual disk associated with the VM. However, in some cases, metadata of a virtual disk may “override” metadata of a VM to which the virtual disk corresponds. For example, if metadata of a particular virtual disk of a VM indicates that the particular virtual disk is a “scratch” or “paging” virtual disk (e.g., that will store information related to memory paging and will not store substantive data related to the VM), then the particular virtual disk may not need to be encrypted with a cryptographic technique that would otherwise comply with the requirements of the VM. Thus, in such cases, the cryptographic agility system may select a lower-security cryptographic technique (or no cryptographic technique) for the particular virtual disk of the VM even though the VM would otherwise require a higher-security cryptographic technique, and a higher-security cryptographic technique may be selected for one or more other virtual disks of the VM (e.g., a primary storage virtual disk of the VM).

Embodiments of the present disclosure improve upon conventional cryptography techniques in which cryptographic algorithms are pre-determined for storage systems such as a VSAN (e.g., at design time) by allowing cryptographic algorithms and/or configurations to be dynamically selected and changed over time based on contextual information, even if a storage system or associated application was not designed to support such functionality. For example, utilizing a cryptographic agility system to dynamically select cryptographic algorithms and/or configurations based on contextual and policy information, techniques described herein improve the security and functioning of devices on which cryptographic operations are performed, such as by, in certain embodiments, ensuring that the most secure and updated cryptographic techniques that are consistent with device constraints and other context information may be utilized, even if such techniques were not available at the time the storage system and/or associated applications were developed.

Additionally, techniques described herein may facilitate an organization's use of uniform policy configuration (e.g., a suite of coordinated policies), such as to orchestrate cryptographic usage across many hosts (e.g., for federated data centers deployed worldwide). Embodiments of the present disclosure may also be used to facilitate migration to new cryptographic algorithms at scale and/or to remove deprecated cryptographic algorithms from use in a centralized and coordinated manner.

Furthermore, by utilizing a cryptographic agility system at the hypervisor level, and utilizing metadata associated with virtual disks and corresponding VMs to dynamically select cryptographic techniques for encrypting virtual disks, embodiments of the present disclosure integrate with existing virtualized storage systems and allow the benefits of cryptographic agility to be obtained without significant changes to the underlying virtualized storage systems or associated applications.

FIG. 1 is a diagram illustrating an example computing environment 100 in which embodiments of the present application may be practiced. As shown, computing environment 100 may include a distributed object-based datastore, such as a software-based “virtual storage area network” (VSAN) environment that leverages the commodity local storage housed in or directly attached (hereinafter, use of the term “housed” or “housed in” may be used to encompass both housed in, or otherwise directly attached) to host machines/servers or nodes 111 of a cluster 110 to provide an aggregate object store 116 to virtual machines (VMs) 112 running on the nodes. The local commodity storage housed in the nodes 111 may include combinations of solid state drives (SSDs) or non-volatile memory express (NVMe) drives 117, magnetic or spinning disks or slower/cheaper SSDs 118, or other types of storages.

In certain embodiments, SSDs 117 may serve as a read cache and/or write buffer (e.g., in the performance tier) in front of magnetic disks or slower/cheaper SSDs 118 (e.g., in the capacity tier) to enhance the I/O performance. In certain other embodiments, both performance and capacity tiers may leverage the same type of storage (e.g., SSDs) for storing the data and performing the read/write operations. Additionally, it should be noted that SSDs 117 may include different types of SSDs that may be used in different layers (tiers) in some embodiments. For example, in some embodiments, the data in the performance tier may be written on a single-level cell (SLC) type of SSD, while the capacity tier may use a quad-level cell (QLC) type of SSD for storing the data.

As further discussed below, each node 111 may include a storage management module (referred to herein as a “VSAN module”) in order to automate storage management workflows (e.g., create objects in the object store, etc.) and provide access to objects in the object store (e.g., handle I/O operations on objects in the object store, etc.) based on predefined storage policies specified for objects in the object store. For example, because a VM may be initially configured by an administrator to have specific storage requirements for its “virtual disk” depending on its intended use (e.g., capacity, availability, input/output operations per second (IOPS), etc.), the administrator may define a storage profile or policy for each VM specifying such availability, capacity, IOPS and the like. As further described below, the VSAN module may then create an “object” for the specified virtual disk by backing it with physical storage resources of the object store based on the defined policy.

A virtualization management platform 105 is associated with cluster 110 of nodes 111. Virtualization management platform 105 enables an administrator to manage the configuration and spawning of VMs on the various nodes 111. As depicted in the embodiment of FIG. 1, each node 111 includes a virtualization layer or hypervisor 113, a VSAN module 114, and hardware 119 (which includes the SSDs 117 and magnetic disks 118 of a node 111). Through hypervisor 113, a node 111 is able to launch and run multiple VMs 112. Hypervisor 113, in part, manages hardware 119 to properly allocate computing resources (e.g., processing power, random access memory, etc.) for each VM 112. Furthermore, as described below, each hypervisor 113, through its corresponding VSAN module 114, may provide access to storage resources located in hardware 119 (e.g., SSDs 117 and magnetic disks 118) for use as storage for storage objects, such as virtual disks (or portions thereof) and other related files that may be accessed by any VM 112 residing in any of nodes 111 in cluster 110.

In one embodiment, VSAN module 114 may be implemented as a “VSAN” device driver within hypervisor 113. In such an embodiment, VSAN module 114 may provide access to a conceptual “VSAN” 115 through which an administrator can create a number of top-level “device” or namespace objects that are backed by object store 116. For example, during creation of a device object, the administrator may specify a particular file system for the device object (such device objects may also be referred to as “file system objects” hereinafter) such that, during a boot process, each hypervisor 113 in each node 111 may discover a/vsan/root node for a conceptual global namespace that is exposed by VSAN module 114. By accessing APIs exposed by VSAN module 114, hypervisor 113 may then determine all the top-level file system objects (or other types of top-level device objects) currently residing in VSAN 115.

When a VM (or other client) attempts to access one of the file system objects, hypervisor 113 may then dynamically “auto-mount” the file system object at that time. In certain embodiments, file system objects may further be periodically “auto-unmounted” when access to objects in the file system objects cease or are idle for a period of time. A file system object (e.g., /vsan/fs_name1, etc.) that is accessible through VSAN 115 may, for example, be implemented to emulate the semantics of a particular file system, such as a distributed (or clustered) virtual machine file system (VMFS) provided by VMware Inc. VMFS is designed to provide concurrency control among simultaneously accessing VMs. Because VSAN 115 supports multiple file system objects, it is able to provide storage resources through object store 116 without being confined by limitations of any particular clustered file system. For example, many clustered file systems may only scale to support a certain amount of nodes 111. By providing multiple top-level file system object support, VSAN 115 may overcome the scalability limitations of such clustered file systems.

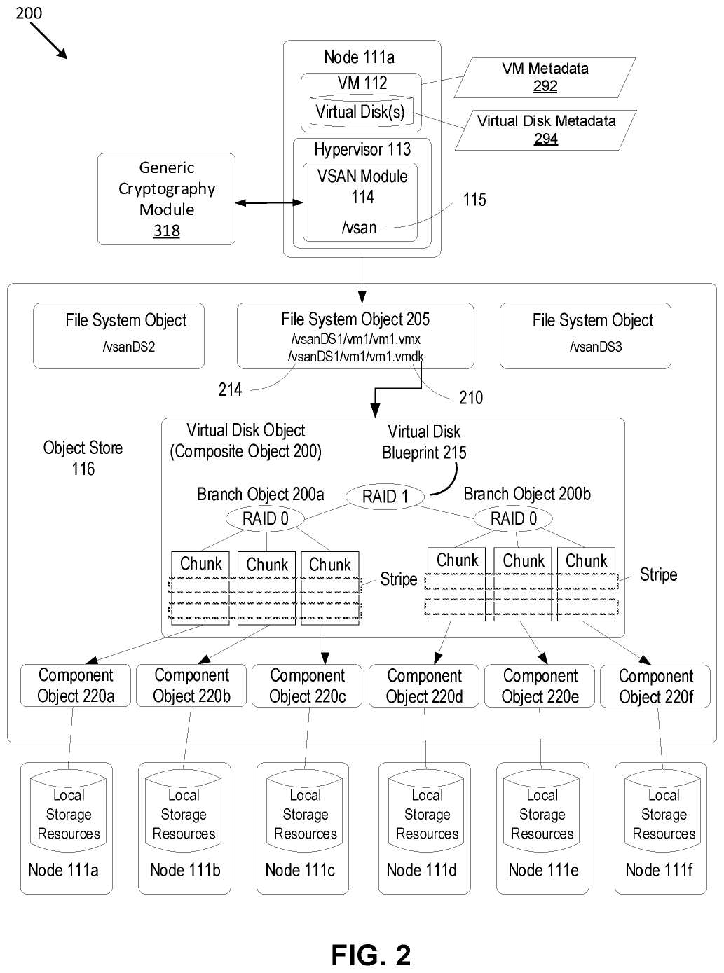

As described in further detail in the context of FIG. 2 below, a file system object may, itself, provide access to a number of virtual disk descriptor files accessible by VMs 112 running in cluster 110. These virtual disk descriptor files may contain references to virtual disk “objects” that contain the actual data for the virtual disk and are separately backed by object store 116. A virtual disk object may itself be a hierarchical, “composite” object that is further composed of “component” objects (again separately backed by object store 116) that reflect the storage requirements (e.g., capacity, availability, IOPs, etc.) of a corresponding storage profile or policy generated by the administrator when initially creating the virtual disk. Each VSAN module 114 (through a cluster level object management or “CLOM” sub-module, in embodiments as further described below) may communicate with other VSAN modules 114 of other nodes 111 to create and maintain an in-memory metadata database (e.g., maintained separately but in synchronized fashion in the memory of each node 111) that may contain metadata describing the locations, configurations, policies and relationships among the various objects stored in object store 116.

This in-memory metadata database is utilized by a VSAN module 114 on a node 111, for example, when a user (e.g., an administrator) first creates a virtual disk for a VM as well as when the VM is running and performing I/O operations (e.g., read or write) on the virtual disk. VSAN module 114 (through a distributed object manager or “DOM” sub-module, in some embodiments) may traverse a hierarchy of objects using the metadata in the in-memory database in order to properly route an I/O operation request to the node (or nodes) that houses (house) the actual physical local storage that backs the portion of the virtual disk that is subject to the I/O operation.

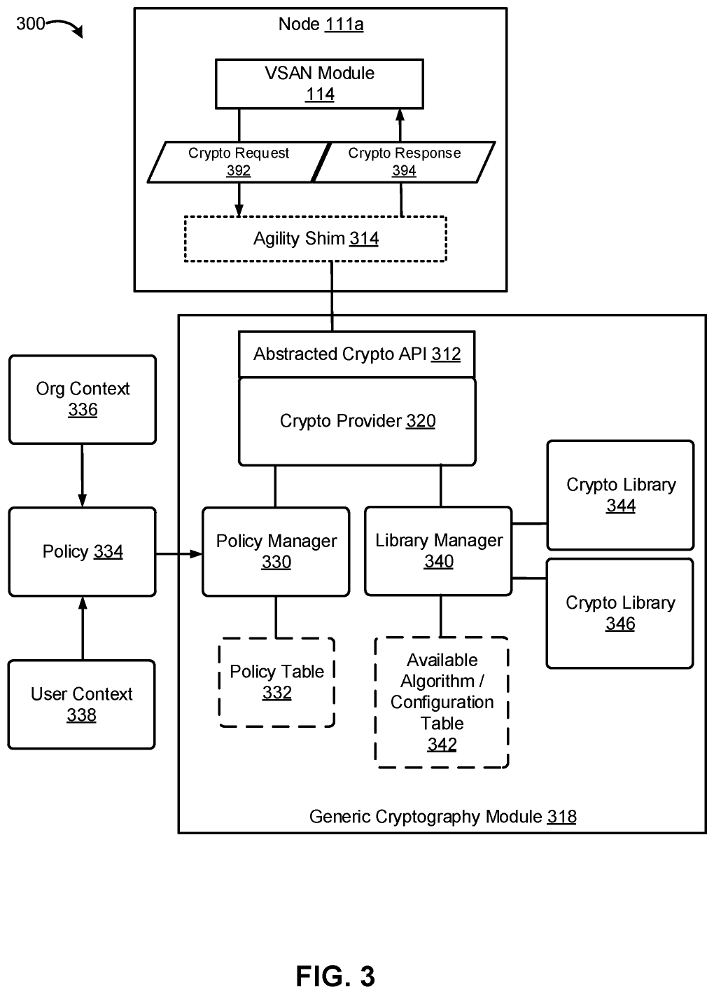

Furthermore, as described in more detail below with respect to FIGS. 2 and 3, VSAN module 114 may interact with a cryptographic agility system that dynamically selects cryptographic techniques for virtual disks, such as based on metadata associated with virtual disk and/or VM to which the virtual disk corresponds.

In some embodiments, one or more nodes 111 of node cluster 110 may be located at a geographical site that is distinct from the geographical site where the rest of nodes 111 are located. For example, some nodes 111 of node cluster 110 may be located at building A while other nodes may be located at building B. In another example, the geographical sites may be more remote such that one geographical site is located in one city or country and the other geographical site is located in another city or country. In such embodiments, any communications (e.g., I/O operations) between the DOM sub-module of a node at one geographical site and the DOM sub-module of a node at the other remote geographical site may be performed through a network, such as a wide area network (“WAN”).

FIG. 2 is a diagram 200 illustrating an example hierarchical structure of objects organized within an object store 116 that represent a virtual disk, according to an example embodiment of the present application. As previously discussed above, a VM 112 running on one of nodes 111 may perform I/O operations on a virtual disk that is stored as a hierarchical composite object 200 in object store 116. Hypervisor 113 may provide VM 112 access to the virtual disk by interfacing with the abstraction of VSAN 115 through VSAN module 114 (e.g., by auto-mounting the top-level file system object 214 corresponding to the virtual disk object 200). For example, VSAN module 114, by querying its local copy of the in-memory metadata database, may be able to identify a particular file system object 205 (e.g., a VMFS file system object in one embodiment, etc.) stored in VSAN 115 that may store a descriptor file 210 for the virtual disk.

Descriptor file 210 may include a reference to composite object 200 that is separately stored in object store 116 and conceptually represents the virtual disk (and thus may also be sometimes referenced herein as a virtual disk object). Composite object 200 may store metadata describing a storage organization or configuration for the virtual disk (sometimes referred to herein as a virtual disk “blueprint”) that suits the storage requirements or service level agreements (SLAs) in a corresponding storage profile or policy (e.g., capacity, availability, IOPs, etc.) generated by a user (e.g., an administrator) when creating the virtual disk.

Depending on the desired level of fault tolerance or performance efficiency, a virtual disk blueprint 215 may direct data corresponding to composite object 200 to be stored in the datastore in a variety of ways. FIG. 2 shows composite object 200 that includes a virtual disk blueprint 215 describing a RAID 1 configuration where two mirrored copies of the virtual disk (e.g., mirrors) are each further striped in a RAID 0 configuration. Data striping refers to segmenting logically sequential data, such as a virtual disk. Each stripe may contain a plurality of data blocks. In some cases, each stripe may also include one or more code blocks (e.g., RAID 5 or RAID 6). As shown, the stripes are then split vertically into different groups of blocks, referred to as chunks, where each chunk is logically represented as a “leaf” or “component” object to which composite object 200 contains a reference. In some cases, different cryptographic techniques may be selected for encrypting different virtual disk objects in a fault-tolerant configuration, such as a RAID configuration. For example, if two mirrored copies of a virtual disk are to be stored in different geographic locations and/or on devices with different resource constraints and/or capabilities, the cryptographic agility system described herein may select different cryptographic technique(s) for encrypting the two different copies.

A stripe, in some embodiments, may also refer to several data and code blocks situated on different rows (which may also be called stripes in some embodiments) and columns (which may also be called chunks), where each column is associated with a physical disk of a host machine.

The metadata accessible by VSAN module 114 in the in-memory metadata database for each component object 220 provides a mapping to or otherwise identifies a particular node 111 in cluster 110 that houses the physical storage resources (e.g., magnetic disks or slower/cheaper SSD 118, etc.) that actually store the chunk (as well as the location of the chunk within such physical resource).

VMs and virtual disks may be associated with metadata indicating attributes (e.g., configured by an administrator). For example, VM 112 is associated with VM metadata 292, which may include one or more tags indicating attributes of VM 112, such as a type of functionality associated with VM 112, a security level of VM 112, one or more users associated with VM 112, one or more applications or types of applications running on VM 112, a grouping or classification associated with VM 112, and/or the like. Furthermore, virtual disk(s) associated with VM 112 may be associated with virtual disk metadata 294, which may indicate types of virtual disks and other attributes.

VM metadata 292 and/or virtual disk metadata 294 may have been associated with VM 112 or a corresponding virtual disk by an administrator, such as through interaction with one or more components of a management plane (e.g., virtualization management platform 105 of FIG. 1), and/or may have been automatically generated (e.g., based on configuration information and/or other attributes of a VM or virtual disk).

VSAN module 114 may interact with a generic cryptography module 318 in order to invoke cryptographic functionality with respect to virtual disks, such as prior to storing such virtual disks in object store 116 and/or on an ongoing basis as circumstances change. Generic cryptography module 318 and integration of cryptographic agility functionality with hypervisor 113 are described in more detail below with respect to FIG. 3.

FIG. 3 is an illustration 300 of example computing components related to cryptographic agility for virtualized data storage, according to embodiments of the present disclosure. Illustration 300 includes node 111a, VSAN module 114, and generic cryptography module 318 of FIG. 2.

While conventional techniques for encrypted data storage in a VSAN generally involve direct integration of one or more fixed cryptographic techniques with the VSAN infrastructure, certain techniques described herein involve abstracting cryptographic functionality away from the VSAN components themselves. As such, an abstracted crypto application programming interface (API) 312 is provided as a means of facilitating cooperation between the VSAN and a separate cryptographic agility system. For instance, VSAN module 114 may make calls to abstracted crypto API 112, in order to invoke cryptographic functionality provided by a cryptographic agility system as described herein. In alternative embodiments, a separate interception component or proxy component intercepts requests by VSAN module to store virtual disks (e.g., in object store 116), and interfaces with crypto provider 320 (e.g., via agility shim 314 and abstracted crypto API 312, directly, and/or via one or more other components) to invoke cryptographic agility functionality. In other embodiments, one or more other components of the hypervisor interact with crypto provider 320 (e.g., via agility shim 314 and abstracted crypto API 312, directly, and/or via one or more other components) to invoke cryptographic agility functionality.

In an example, VSAN module 114, prior to storing a virtual disk (e.g., upon creation of the virtual disk), sends a request to crypto provider 320, via a call to abstracted crypto API 312, to dynamically select a cryptographic technique for encrypting the virtual disk before it is stored.

The cryptographic agility system includes abstracted crypto API 312 and, in some embodiments, an optional agility shim 314, as well as crypto provider 320, policy manager 330, and library manager 340. In some embodiments, while depicted as separate components, agility shim 314, abstracted crypto API 312, policy manager 330, and/or library manager 340 may be part of crypto provider 120.

Agility shim 314 generally intercepts API calls (e.g., calls to functions of abstracted crypto API 312) and redirects them to crypto provider 320 via abstracted crypto API 312. Shims generally allow new software components to be integrated with existing software components by intercepting, modifying, and/or redirecting communications. As such, agility shim 314 allows VSAN module 114 or another component to interact with crypto provider 320 even though such a component itself may have no knowledge of crypto provider 320. For instance, VSAN module 114 may make generic cryptographic function calls (e.g., requesting that a virtual disk be encrypted), and these generic function calls may be intercepted by agility shim 314 (e.g., if such a shim is needed) and redirected to crypto provider 320 via the abstracted crypto API 312 exposed by crypto provider 320.

It is noted that while embodiments of the present disclosure are depicted on node 111a and generic cryptography module 318, alternative embodiments may involve various components being located on more or fewer computing devices. In some cases, aspects of the cryptographic agility system may be implemented in a distributed fashion across a plurality of computing devices. In certain embodiments, said components may be located on a single computing device. For example, the functionality described with respect to generic cryptography module 318 may be located on node 111a. In certain embodiments, generic cryptography module 318 may be located with the hypervisor on node 111a.

In certain embodiments, generic cryptography module 318 comprises a physical or virtual computing device, such as a server computer, on which components of the cryptographic agility system, such as crypto provider 320, policy manager 330, and/or library manager 340, reside. For example, generic cryptography module 318 may represent a virtual computing instance (VCI) or a physical computing device. Generic cryptography module 318 may be connected to node 111a via a network or may be located on node 111a.

Crypto provider 320 generally performs operations related to dynamically selecting cryptographic techniques (e.g., based on contextual information related to requests for cryptographic operations), performing the requested cryptographic operations according to the selected techniques, and providing results of the operations to the requesting components or to other recipient components. Cryptographic techniques may include cryptographic algorithms (e.g., included in one or more libraries) and/or specific configurations of cryptographic algorithms, as described herein. According to certain embodiments, policies are defined by an enterprise administrative team deploying a storage system, rather than being defined by a storage system user. Accordingly, policies may be used to determine (e.g., on behalf of users) which cryptographic techniques to use (e.g., based on organizational policies). Policy-based selection of cryptographic techniques may be based on contextual information related to a cryptographic request.

In certain aspects, crypto provider 320 has two major subsystems, policy manager 330 and library manager 340. Policy manager 330 performs operations related to cryptographic policies, such as receiving policies defined by users and storing information related to the policies in a policy table 332. According to certain embodiments, a centralized policy control server may orchestrate policy across a plurality of generic cryptography modules, such as including generic cryptography module 318. For example, an administrator or other user may configure one or more policies at a centralized policy control server, and the one or more policies may be distributed to a plurality of generic cryptography modules for storage by corresponding policy managers, such as including policy manager 330. In an example, a policy 334 is based on one or more of an organizational context 336 and a user context 338 related to a cryptographic request. In some embodiments, a policy may map a cryptographic request and its associated context information to attributes of cryptographic techniques, such as a particular cryptographic technique in a particular cryptographic library and a particular set of parameters for configuring the particular cryptographic technique.

Organizational context 136 may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, policy 334 may indicate that if a cryptographic request is received in relation to a device (e.g., node 111a or different device on which a virtual disk is to be stored) associated with a particular geographic region, associated with a particular industry, and/or within the jurisdiction of a particular governmental entity, then crypto provider 320 must select a cryptographic technique that meets one or more conditions (e.g., having a particular security rating and/or being configured to protect against particular types of threats) in order to comply with relevant laws, regulations, or mandates.

User context 338 may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. In some cases, aspects of user context 338 may be determined from metadata associated with a virtual disk and/or associated with a VCI (e.g., VM) to which the virtual disk corresponds. In some embodiments, aspects of user context may include a size of a virtual disk, a user associated with creation or modification of a virtual disk or VM, a name of a virtual disk or VM, contents of a virtual disk or VM, application(s) running on a VM and/or storing data on a virtual disk, a type or purpose of a VM or virtual disk, a category or classification of a VM or virtual disk, and/or the like.

For example, policy 334 may indicate that if a cryptographic request is received in relation to a particular category of user (e.g., administrators, general users, or the like), relating to a particular type of data (e.g., tagged as sensitive or meeting characteristics associated with sensitivity, such as being financial or medical data), relating to data having a particular level of classification (e.g., based on classification markers associated with the data), associated with a particular application or type of application, associated with a particular platform (e.g., operating system), associated with a device with particular capabilities or other attributes (e.g., a device having a certain amount of processing or memory resources, or having an accelerator), and/or in relation to a device in a particular location (e.g., geographic location), then crypto provider 320 should select a cryptographic technique that meets one or more conditions. In certain embodiments, a policy may simply specify an allowed list of ciphers or an allowed list of cryptographic technique characteristics. In some cases, a policy 334 may relate to resource constraints (e.g., based on available processing, memory, or network resources), such as specifying that cryptographic techniques must be selected based on resource availability (e.g., how much of a device's processing and/or memory resources are currently utilized, and the like) and/or capabilities (e.g., whether a device is associated with an accelerator) associated with devices, while in other embodiments crypto provider 320 selects cryptographic techniques based on resource constraints independently of policy manager 330 (e.g., for all cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. Policies may also relate to privacy-preservation, such as requiring homomorphic encryption or confidential computing, or specific types of homomorphic encryption or confidential computing, under certain circumstances. In one example, once all cryptographic techniques meeting the security requirements for a cryptographic request are identified based on policies, a cryptographic technique is selected from these policy-compliant cryptographic techniques based on resource constraints.

Policy table 332 stores information related to policies, such as policy 334. In some embodiments, policy table 332 maps various contextual conditions (e.g., relating to organizational context and/or user context) to cryptographic technique characteristics (e.g., whether techniques have certain security ratings, protect against certain threats, have certain resource utilization ratings, and the like). For example, a contextual condition may be the use of a certain type of application, a certain type of VM, a certain type of virtual disk, a certain user or type of user, a certain type of data, or a particular geographic location. A cryptographic technique characteristic may be, for example, a security rating (e.g., 0-10), whether the cryptographic technique is quantum-safe, what level of resource requirements the cryptographic technique has for a particular type of resource (e.g., memory, processor, or network resources), whether the cryptographic technique is homomorphic, or the like. Thus, when cryptographic requests are received, policy table 332 may be used to determine whether the cryptographic requests are associated with any characteristics included in policies and, if so, what cryptographic technique characteristics are required by the policies for servicing the requests.

Library manager 340 generally manages cryptographic libraries containing cryptographic algorithms. For example crypto libraries 344 and 346 each include various cryptographic algorithms and/or techniques, each of which may include configurable parameters, such as key size, choice of elliptic curve, algorithm sizing parameters, and the like, and characteristics such as ciphertext size. For instance, cryptographic techniques (e.g., algorithms and/or specific configurations of algorithms, and/or confidential computing techniques) may be registered with library manager 340 along with information indicating characteristics of the cryptographic techniques. Examples of algorithms include data encryption standard (DES), triple DES, advanced encryption standard (AES), the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, Diffie-Hellman (DH) encryption, Elliptic Curve DH (ECDH) encryption, digital signatures such as Digital Signature Algorithm (DSA) and Elliptic Curve DSA (ECDSA), cryptographic hash functions such as Secure Hash Algorithm 2 or 3 (SHA-2 or SHA-3), and others. There are many other types of encryption algorithms, and the algorithms listed herein are included as examples. Some algorithms may, for example, involve symmetric key encryption or asymmetric key encryption, digital signatures or cryptographic hash functions, and/or the like. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with a security rating, an indication of threats protected against by the technique, indications of the resource requirements of the technique, an indication of whether the technique is homomorphic, and/or the like.

Information related to cryptographic techniques registered with library manager 340 is stored in available algorithm/configuration table 342. For instance, available algorithm/configuration table 342 may store identifying information of each available cryptographic technique (e.g., an identifier of a library, an identifier of an algorithm in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “symmetric key encryption algorithms configured with a key size of 200 bits or larger.” Thus, if tags are associated with this type (e.g., including security ratings, recourse requirement ratings, and the like), any specific cryptographic techniques of this type (being symmetric key encryption algorithms, and being configured with a key size of 200 bits or more) will be considered to be associated with these tags. In another example, fuzzy logic and/or machine learning techniques may be employed, such as based on historical cryptographic data indicating which cryptographic techniques were utilized for cryptographic requests having particular characteristics. In some embodiments, tags may be associated with specific configurations of cryptographic algorithms, such as assigning a security rating to a particular set of configuration parameters for a particular cryptographic algorithm or type of algorithm.

Tags associated with cryptographic techniques may be updated as appropriate over time, such as based on input from a user (e.g., an administrator, security operations professional, and/or the like). For example, a user may provide input upgrading or downgrading a security rating for a particular cryptographic technique, type of cryptographic technique, or configuration of a cryptographic technique (e.g., from 10 out of 10 to 8 out of 10), such as based on changed understandings of vulnerabilities or strengths of particular techniques.

By allowing cryptographic techniques and libraries to be registered and deregistered with library manager 340 on an ongoing basis, and to be associated with metadata such as tags that can be dynamically updated, embodiments of the present disclosure allow the pool of possible cryptographic techniques to be continuously updated to meet new conditions and threats. For example, as new libraries are developed, these libraries may be added to library manager 340, and the cryptographic techniques in the library may be used by crypto provider 320 in servicing requests associated with a storage system such as a VSAN without the storage system or associated applications having any awareness of the new libraries. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation. In one particular example, a new cryptographic technique is tagged as quantum safe, meaning that the cryptographic technique was developed to be resistant to being decoded by quantum computers. For instance, the new cryptographic technique may have a high security rating (e.g., 10 out of 10) as well as high resource requirements. The new cryptographic technique is registered with library manager 340, and information about the new cryptographic technique and its characteristics is stored in available algorithm/configuration table 342. Thus, the new cryptographic algorithm is available to be selected by crypto provider 320 for servicing cryptographic requests (e.g., from VSAN module 114).

Continuing with the example, a policy 334 states that cryptographic requests relating to virtual disks storing data that is long-lived (e.g., of a type that must be protected over a long amount of time, such as many years) is to be encrypted using a quantum-safe cryptographic technique if such a technique is available, unless device resource constraints prohibit the use of such a technique. Long-lived data may include, for example, classified government data, certain types of personally-identifiable information, and the like. Data that is not long-lived may include, for example, a code or password that expires after a short amount of time, a credit card number that is updated at regular intervals, network configuration data that changes on a regular basis, and the like. Whether or not data in a file is long-lived data may be determined in some cases based on metadata associated with the file. A policy 134 may also state that if a cryptographic request relates to long-lived data but resource constraints prohibit the use of a technique tagged as quantum-safe, then a combination of cryptographic techniques with resource requirements consistent with the resource constraints should be utilized, such as in a repeating pattern.

Thus, when VSAN module 114 submits a cryptographic request (e.g., via a call to a generic cryptographic function provided by abstracted crypto API 312) to encrypt a virtual disk that includes long-lived data, crypto provider 320 determines based on information stored in policy table 332 that a quantum-safe cryptographic technique is to be used if possible, or otherwise to use a combination of cryptographic techniques. Crypto provider 320 determines based on information in available algorithm/configuration table 342 that the new cryptographic technique is quantum-safe. Next, crypto provider 320 analyzes resource constraints related to the cryptographic request to determine if the new cryptographic technique can be performed. If crypto provider 320 determines that device(s) and/or network(s) involved can support the new cryptographic technique (e.g., based on available resources), then crypto provider 320 selects the new cryptographic technique for servicing the cryptographic request, and provides a response to VSAN module 114 (e.g., via agility shim 314) accordingly. Alternatively, if crypto provider 320 determines that device(s) and/or network(s) involved cannot support the new cryptographic technique (e.g., based on available resources), then crypto provider 320 selects a plurality of cryptographic techniques consistent with the available resources of the device(s) and/or network(s) for servicing the cryptographic request according to a pattern, and provides a response to VSAN module 114 (e.g., via agility shim 314) accordingly. In some cases, the response sent from crypto provider 320 to VSAN module 114 includes data encrypted using the selected technique(s) (e.g., the encryption may be performed by generic cryptography module 318 and/or one or more associated components). In other cases, the response includes information related to performing the selected technique(s) to encrypt the data, and the encryption is performed by the entity from which the request was sent or by another entity.

In some cases, more than one cryptographic technique may be selected for servicing a given cryptographic request together, without utilizing a pattern. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations).

Virtual disks encrypted using techniques dynamically selected by crypto provider 320 as described herein may then be stored, such as in object store 116 of FIG. 2. When data from such an encrypted virtual disk is retrieved from object store 116 of FIG. 2, such as via a read request sent by an application or VM to the hypervisor, the encrypted data is retrieved and decrypted (e.g., by crypto provider 320) using the one or more cryptographic techniques that were used to encrypt the data in the virtual disk prior to storage.

Furthermore, VSAN module 114 or another component may interact with crypto provider 320 (e.g., via abstracted crypto API 312) over time (e.g., at regular intervals) (or crypto provider 320 may itself trigger such action) to ensure that virtual disks that have previously been encrypted and stored continue to be encrypted with optimal policy-compliant encryption techniques. For examples, crypto provider 320 may determine whether a given virtual disk is encrypted with a cryptographic technique that best complies with applicable policies and contextual information, and may change the cryptographic technique used to encrypt the virtual disk if a more optimal or compliant technique is available (e.g., based on new cryptographic techniques becoming available, changes in policies and/or contextual information, and/or the like).

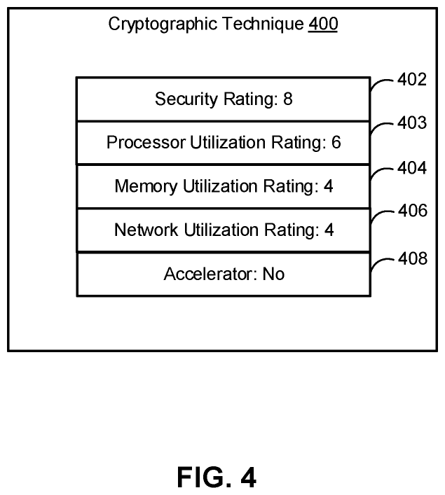

FIG. 4 depicts an example of tagging cryptographic techniques based on attributes, according to embodiments described herein.

A cryptographic technique 400 comprises one or more cryptographic algorithms and/or configurations of algorithms. For instance cryptographic technique 400 may be included in a cryptographic library, and may be registered with library manager 340 of FIG. 3 as an available cryptographic technique for use in a cryptographic agility system.

Tags 402, 403, 404, 406, and 408 are associated with cryptographic technique 400 to indicate characteristics of cryptographic technique 400. For example, these tags may be added by an administrator at the time cryptographic technique 400 is registered with library manager 140 of FIG. 1. While not depicted, cryptographic technique 400 may also be associated with other tags related to, for example, threats protected against by cryptographic technique 400, whether cryptographic technique 400 is quantum-safe, whether cryptographic technique 400 is homomorphic, and/or the like.

Tags 402, 403, 404, 406, and 408 may be based on a variety of characteristics of cryptographic technique 400, such as the nature of involved cryptographic algorithm(s), key size, size of lattice, which elliptic curve is utilized, number of bits of security, whether accelerators are used, ciphertext size, whether side channel attacks are protected against (e.g., resulting in higher resource usage), and/or the like.

Tag 402 indicates that cryptographic technique 400 has a security rating of 8. It is noted that a numerical security rating in a particular range (e.g., 1-10) is included as an example, and other techniques for indicating a level of security may be used.

Tag 403 indicates a processor utilization rating of 6. In an example, processor utilization ratings may range from 0-10, and generally indicate an amount of processing resources required by a cryptographic technique.

Tag 404 indicates a memory utilization rating of 4. In an example, memory utilization ratings may range from 0-10, and generally indicate an amount of memory resources required by a cryptographic technique.

Tag 406 indicates a network utilization rating of 4. In an example, network utilization ratings may range from 0-10, and generally indicate an amount of network resources required by a cryptographic technique.

Tag 408 indicates that an accelerator is not used by cryptographic technique 300.

Tags 402, 403, 404, 406, and 408 are included as examples, and other types of tags may be included. Tags 402, 403, 404, 406, and 408 generally allow a cryptographic agility system to identify which cryptographic techniques are best suited for a given cryptographic request or requests, such as related to a virtual disk, based on various characteristics.

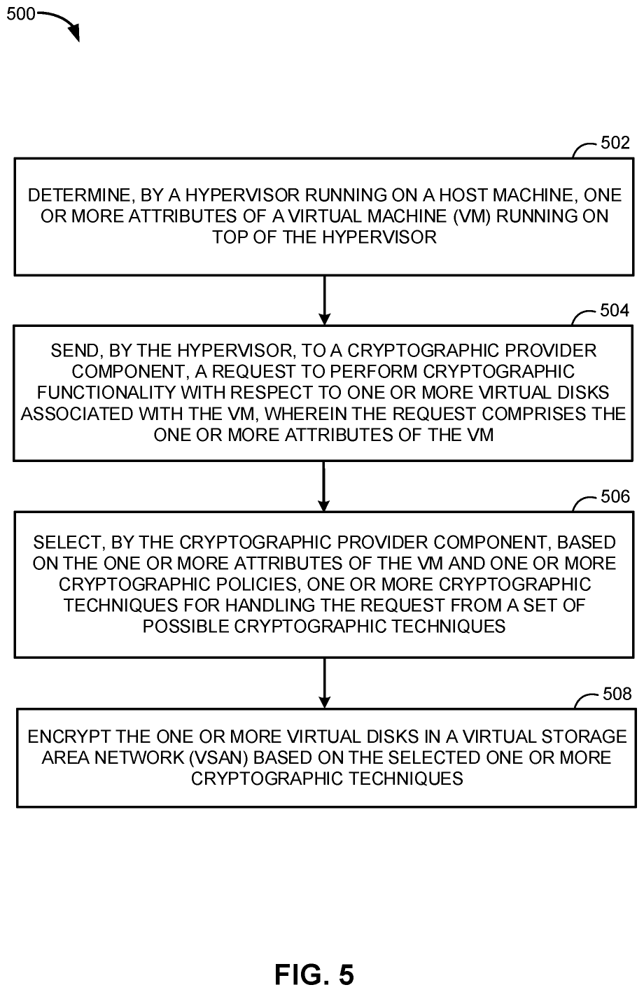

FIG. 5 depicts example operations 500 related to cryptographic agility for virtualized data storage according to embodiments of the present disclosure. For example, operations 500 may be performed by one or more components of the cryptographic agility system described above with respect to FIGS. 1-4.

Operations 500 begin at step 502, with determining, by a hypervisor running on a host machine, one or more attributes of a virtual machine (VM) running on top of the hypervisor. In certain embodiments, the determining of the one or more attributes of the VM is based on one or more tags associated with the VM.

Operations 500 continue at step 504, with sending, by the hypervisor, to a cryptographic provider component, a request to perform cryptographic functionality with respect to one or more virtual disks associated with the VM, wherein the request comprises the one or more attributes of the VM.

Operations 500 continue at step 504, with selecting, by the cryptographic provider component, based on the one or more attributes of the VM and one or more cryptographic policies, one or more cryptographic techniques for handling the request from a set of possible cryptographic techniques.

In some embodiments, the one or more virtual disks comprise a first virtual disk and a second virtual disk, and the selecting of the one or more cryptographic techniques comprises selecting a first cryptographic technique for the first virtual disk based on the one or more attributes of the VM and one or more first attributes of the first virtual disk and selecting a second cryptographic technique for the second virtual disk based on the one or more attributes of the VM and one or more second attributes of the second virtual disk. For example, the first cryptographic technique may have a higher level of security than the second cryptographic technique. In an example, the one or more first attributes of the first virtual disk indicate that the first virtual disk is a primary storage disk of the VM and the one or more second attributes of the second virtual disk indicate that the second virtual disk is a scratch or paging disk. In some embodiments, the first virtual disk and the second virtual disk are different disks in a redundant array of independent disks (RAID) configuration. In certain embodiments, the selecting of the second cryptographic technique for the second virtual disk based on the one or more attributes of the VM and the one or more second attributes of the second virtual disk comprises determining that the one or more second attributes of the second virtual disk override the one or more attributes of the VM based on a cryptographic policy of the one or more cryptographic policies.

In some embodiments, the selecting of the one or more cryptographic techniques is further based on one or more resource constraints associated with one or more devices related to the one or more virtual disks.

In certain embodiments, the selecting of the one or more cryptographic techniques is further based on one or more geographic locations associated with the one or more virtual disks.

Operations 500 continue at step 504, with encrypting the one or more virtual disks in a virtual storage area network (VSAN) based on the selected one or more cryptographic techniques.

Some embodiments further comprise determining, by the hypervisor, that a given virtual disk of the one or more virtual disks is to be moved or replicated to a different geographic location and selecting, by the cryptographic provider component, a different cryptographic technique for the given virtual disk based on the different geographic location. For example, in some cases, a VSAN may have backup and replication services that do not necessarily move a virtual disk but make a remote copy of it and, in such cases, an alternate cryptographic technique might be used on the replica (e.g., the remote copy of the virtual disk) for various reasons such as geographic region.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of cryptographic agility for virtualized data storage, comprising:
determining, by a hypervisor running on a host machine, one or more attributes of a virtual machine (VM) running on top of the hypervisor;
sending, by the hypervisor, to a cryptographic provider component, a request to perform cryptographic functionality with respect to one or more virtual disks associated with the VM, wherein the request comprises the one or more attributes of the VM;
selecting, by the cryptographic provider component, based on the one or more attributes of the VM and one or more cryptographic policies, one or more cryptographic techniques for handling the request from a set of possible cryptographic techniques; and
encrypting the one or more virtual disks in a virtual storage area network (VSAN) based on the selected one or more cryptographic techniques.

2. The method of claim 1, wherein the determining of the one or more attributes of the VM is based on one or more tags associated with the VM.

3. The method of claim 1, wherein:
the one or more virtual disks comprise a first virtual disk and a second virtual disk; and
the selecting of the one or more cryptographic techniques comprises:
selecting a first cryptographic technique for the first virtual disk based on the one or more attributes of the VM and one or more first attributes of the first virtual disk; and
selecting a second cryptographic technique for the second virtual disk based on the one or more attributes of the VM and one or more second attributes of the second virtual disk.

4. The method of claim 3, wherein the first cryptographic technique has a higher level of security than the second cryptographic technique.

5. The method of claim 4, wherein the one or more first attributes of the first virtual disk indicate that the first virtual disk is a primary storage disk of the VM and the one or more second attributes of the second virtual disk indicate that the second virtual disk is a scratch or paging disk.

6. The method of claim 3, wherein the first virtual disk and the second virtual disk are different disks in a redundant array of independent disks (RAID) configuration.

7. The method of claim 3, wherein the selecting of the second cryptographic technique for the second virtual disk based on the one or more attributes of the VM and the one or more second attributes of the second virtual disk comprises determining that the one or more second attributes of the second virtual disk override the one or more attributes of the VM based on a cryptographic policy of the one or more cryptographic policies.

8. The method of claim 1, further comprising:
determining, by the hypervisor, that a given virtual disk of the one or more virtual disks is to be moved or replicated to a different geographic location; and
selecting, by the cryptographic provider component, a different cryptographic technique for the given virtual disk based on the different geographic location.

9. The method of claim 1, wherein the selecting of the one or more cryptographic techniques is further based on one or more resource constraints associated with one or more devices related to the one or more virtual disks.

10. The method of claim 1, wherein the selecting of the one or more cryptographic techniques is further based on one or more geographic locations associated with the one or more virtual disks.

11. A system for cryptographic agility for virtualized data storage, comprising:
at least one memory; and
at least one processor coupled to the at least one memory, the at least one processor and the at least one memory configured to:
determine, by a hypervisor running on a host machine, one or more attributes of a virtual machine (VM) running on top of the hypervisor;
send, by the hypervisor, to a cryptographic provider component, a request to perform cryptographic functionality with respect to one or more virtual disks associated with the VM, wherein the request comprises the one or more attributes of the VM;
select, by the cryptographic provider component, based on the one or more attributes of the VM and one or more cryptographic policies, one or more cryptographic techniques for handling the request from a set of possible cryptographic techniques; and
encrypt the one or more virtual disks in a virtual storage area network (VSAN) based on the selected one or more cryptographic techniques.

12. The system of claim 11, wherein the determining of the one or more attributes of the VM is based on one or more tags associated with the VM.

13. The system of claim 11, wherein:
the one or more virtual disks comprise a first virtual disk and a second virtual disk; and
the selecting of the one or more cryptographic techniques comprises:
selecting a first cryptographic technique for the first virtual disk based on the one or more attributes of the VM and one or more first attributes of the first virtual disk; and
selecting a second cryptographic technique for the second virtual disk based on the one or more attributes of the VM and one or more second attributes of the second virtual disk.

14. The system of claim 13, wherein the first cryptographic technique has a higher level of security than the second cryptographic technique.

15. The system of claim 14, wherein the one or more first attributes of the first virtual disk indicate that the first virtual disk is a primary storage disk of the VM and the one or more second attributes of the second virtual disk indicate that the second virtual disk is a scratch or paging disk.

16. The system of claim 13, wherein the first virtual disk and the second virtual disk are different disks in a redundant array of independent disks (RAID) configuration.

17. The system of claim 13, wherein the selecting of the second cryptographic technique for the second virtual disk based on the one or more attributes of the VM and the one or more second attributes of the second virtual disk comprises determining that the one or more second attributes of the second virtual disk override the one or more attributes of the VM based on a cryptographic policy of the one or more cryptographic policies.

18. The system of claim 11, wherein the at least one processor and the at least one memory are further configured to:
determine, by the hypervisor, that a given virtual disk of the one or more virtual disks is to be moved or replicated to a different geographic location; and
select, by the cryptographic provider component, a different cryptographic technique for the given virtual disk based on the different geographic location.

19. The system of claim 11, wherein the selecting of the one or more cryptographic techniques is further based on one or more resource constraints associated with one or more devices related to the one or more virtual disks.

20. A non-transitory computer readable medium storing instructions that, when executed by one or more processors, cause the one or more processors to:
determine, by a hypervisor running on a host machine, one or more attributes of a virtual machine (VM) running on top of the hypervisor;
send, by the hypervisor, to a cryptographic provider component, a request to perform cryptographic functionality with respect to one or more virtual disks associated with the VM, wherein the request comprises the one or more attributes of the VM;
select, by the cryptographic provider component, based on the one or more attributes of the VM and one or more cryptographic policies, one or more cryptographic techniques for handling the request from a set of possible cryptographic techniques; and
encrypt the one or more virtual disks in a virtual storage area network (VSAN) based on the selected one or more cryptographic techniques.
